(19) United States
(12) Patent Application Publication
(10) Pub. No.: US 2026/0177118 A1
(43) Pub. Date: Jun. 25, 2026

(54) BRAKE DISC FOR DISC BRAKES AND METHOD FOR MAKING A BRAKE DISC FOR DISC BRAKES

(71) Applicant: BREMBO N.V., Bergamo (IT)

(72) Inventors: Tommaso TARONI, Bergamo (IT); Francesco BERTONI, Bergamo (IT); Stefano MEDICI, Bergamo (IT); Alberto GRIGIS, Bergamo (IT); Simone BIONDO, Bergamo (IT)

(73) Assignee: BREMBO N.V., Bergamo (IT)

(21) Appl. No.: 19/424,796

(22) Filed: Dec. 18, 2025

(30) Foreign Application Priority Data
Dec. 20, 2024 (IT) 102024000029385

(51) Int. Cl. F16D 65/12; C22C 14/00; C23C 4/10; C23C 24/04; F16D 65/02

(52) U.S. Cl. CPC F16D 65/127; F16D 65/125; C22C 14/00; C23C 4/10; C23C 24/04; F16D 2065/132; F16D 2200/0013; F16D 2200/0021; F16D 2250/0046

(57) ABSTRACT

A brake disc has a braking band made of gray cast iron or steel and having two opposing braking surfaces. The brake disc has a base layer covering at least one of the two braking surfaces and a bond layer interposed between the base layer and the at least one of the two braking surfaces. The base layer consists of a matrix of titanium and/or a titanium alloy including one or more carbides and defines a tribologically active surface of the brake disc, or the base layer consists of a layer of titanium and/or a titanium alloy and is covered by a coating layer defining a tribologically active surface of the brake disc. At an interface between the bond layer and the braking band there is a first intermediate interfusion layer. At an interface between the base layer and the bond layer there is a second intermediate interfusion layer.

### CROSS-REFERENCE TO RELATED APPLICATION

This application claims priority to Italian Patent Application No. 102024000029385 filed on Dec. 20, 2024, the contents of which are incorporated by reference in their entirety.

### FIELD OF APPLICATION

The present invention relates to a disc for disc brakes and a method for making a disc for disc brakes.

### PRIOR ART

A brake disc of a vehicle's disc braking system comprises an annular structure, or braking band, and a central fastening element, known as a bell, through which the disc is fastened to the rotating part of a vehicle suspension, for example a hub. The braking band is equipped with opposing braking surfaces suitable for cooperating with friction elements (brake pads), housed in at least one caliper body placed astride the braking band and integral with a non-rotating component of the vehicle suspension. The controlled interaction between the opposing brake pads and the opposing braking surfaces of the braking band causes a braking action by friction that allows the vehicle to decelerate or stop.

Generally, the brake disc is made of gray cast iron or steel. This material allows, in fact, to obtain good braking performance (especially in terms of wear containment) at relatively low costs. Discs made of carbon or carbon-ceramic materials offer far superior performance, but at much higher costs.

The limits of traditional discs, in cast iron or steel, are linked to excessive wear. As for gray cast iron discs, another very negative aspect is linked to excessive surface oxidation, with consequent rust formation. This aspect impacts both the performance of the brake disc and its appearance, as rust on the brake disc is unacceptable to the user from an aesthetic point of view.

This problem is particularly accentuated in brake discs for electric cars.

In fact, due to the regenerative power, electric cars foresee a reduction in the number of conventional brake applications. This leads to greater exposure of the disc to atmospheric agents per unit of time or per km traveled.

Corrosive products on the braking surface of the brake disc will therefore be present in greater quantities and for longer, increasing the phenomenon of rust formation. All this not only has negative consequences on the aesthetics of the disc, but also significantly affects braking performance and comfort.

One proposed solution is to paint the braking surface of the disc. The effectiveness of this solution is, however, limited in time as the paint is inevitably and quickly subject to wear. Furthermore, the paint layer negatively affects braking performance.

Attempts have been made to address these problems by making the discs in gray cast iron or steel with a protective coating. The protective coating serves on the one hand to reduce the wear of the disc, and on the other to protect the gray cast iron base from surface oxidation, thus avoiding the formation of a layer of rust.

Titanium and its alloys have some very attractive properties that allow them to be used in many sectors. Some of the aforementioned properties are: excellent corrosion and erosion resistance; low density, which confers high specific strength-to-weight ratios, allowing for lighter and more resistant structures; high temperature resistance and, in some cases, cryogenic properties.

Titanium and its alloys are, however, also characterized by modest tribological properties, such as poor resistance to abrasive wear, poor resistance to wear due to fatigue (fretting), and a high friction coefficient. All this has significantly limited the use of titanium and its alloys in mechanical engineering applications, and in particular in the brake disc sector.

The problem of tribological properties is related to the crystalline structure and reactivity of titanium and can be largely overcome by appropriate thermochemical treatments that superficially modify the titanium substrate making it harder. One of the most common thermochemical treatments of titanium and its alloys is nitriding.

To avoid the technical complexity of titanium nitriding, coatings based on Ti and Ti alloys have been proposed, made with the Cold Gas Spray (CGS) deposition technique, as described in EP4174212. These coatings have proven to be resistant to corrosion and wear, but suffer under operating conditions of delamination and generalized detachment.

The protective coatings currently available and applied to discs are made of particularly corrosion-resistant materials such as titanium and its alloys. While offering resistance to wear, they are subject to flaking that causes them to detach from the disc itself. Furthermore, such coatings are sensitive to the generation of thermal cracks during use and to the presence of cracks during their application.

Alternatively, coatings with iron-based metals (e.g. steel), made with the Laser Metal Deposition (LMD) technique, have been proposed. These coatings have proven to be an improvement over uncoated cast iron discs. However, although less prone to flaking and delamination than titanium or titanium alloy coatings, they do not meet the expectations of use. These coatings are, in fact, not very resistant to corrosion, having a resistance of a few tens of hours in SST.

Therefore, there is a particularly strong need for brake discs in gray cast iron or steel with coatings that ensure resistance to corrosion and wear, and at the same time are less prone to flaking or delamination, thus ensuring adequate thermal and mechanical performance and showing reliability over time.

### SUMMARY OF THE INVENTION

Therefore, the main purpose of the present invention is to eliminate, or at least reduce, the aforementioned problems relating to the known technique, by providing a brake disc for disc brakes that is resistant to corrosion and wear, and at the same time is less subject to flaking or delamination, thus ensuring adequate thermal and mechanical performance and showing reliability over time.

A further object of the present invention is to provide a brake disc for disc brakes that is easy and inexpensive to manufacture.

A further object of the present invention is to provide a method for making a brake disc for disc brakes that is resistant to corrosion and wear, and at the same time is less subject to flaking or delamination, in a way that is easily applicable on an industrial scale.

### DESCRIPTION OF THE DRAWINGS

The technical characteristics of the invention can clearly be seen in the content of the claims below and its advantages will become more readily apparent in the detailed description that follows, made with reference to the accompanying drawings, which illustrate one or more embodiments that are purely exemplary and not limiting, in which:

FIG. 1 shows a top plan view of a brake disc according to a first embodiment of the present invention;

FIG. 2 shows a sectional view of the disc of FIG. 1 according to the section line II-II indicated therein;

FIG. 3 shows an enlarged detail of the section of FIG. 2 framed in regard II;

FIG. 4 shows a top plan view of a brake disc according to a second embodiment of the present invention;

FIG. 5 shows a sectional view of the disc of FIG. 4 according to the section line V-V indicated therein; and

FIG. 6 shows an enlarged detail of the section of FIG. 5 framed in the VI view.

### DETAILED DESCRIPTION

With reference to the aforementioned figures, 1 indicates a brake disc according to the present invention.

In accordance with a general embodiment of the invention, illustrated in the attached Figures, the brake disc 1 comprises a braking band 2, equipped with two opposing braking surfaces 2a and 2b, each of which at least partially defines one of the two main faces of the disc.

The braking band 2 can be made of gray cast iron or steel.

Preferably, the braking band 2 is made of gray cast iron. Preferably, the entire brake disc 1 is made of gray cast iron. In the following description, reference will therefore be made to a gray cast iron disc, without however excluding the possibility that it is made of steel.

The brake disc 1 includes:
a base layer 30 covering at least one of the two braking surfaces 2a, 2b of the braking band 2; and
a bond layer 3 which is interposed between the base layer 30 and the braking surface 2a, 2b.

The bond layer 3 is made in direct contact with the braking surface.

As will be clarified below, the expression “made in direct contact with the braking surface” means that the bond layer 3 was formed directly on the latter without the prior deposition of a bond layer. This expression includes the possibility of forming any intermediate layers deriving from the metallurgical interaction between the bond layer and the braking surface determined by the deposition of the bond layer 3.

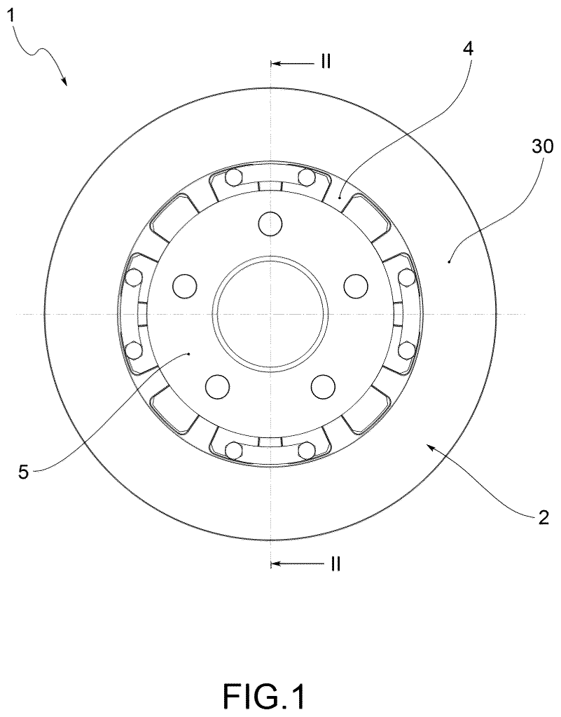

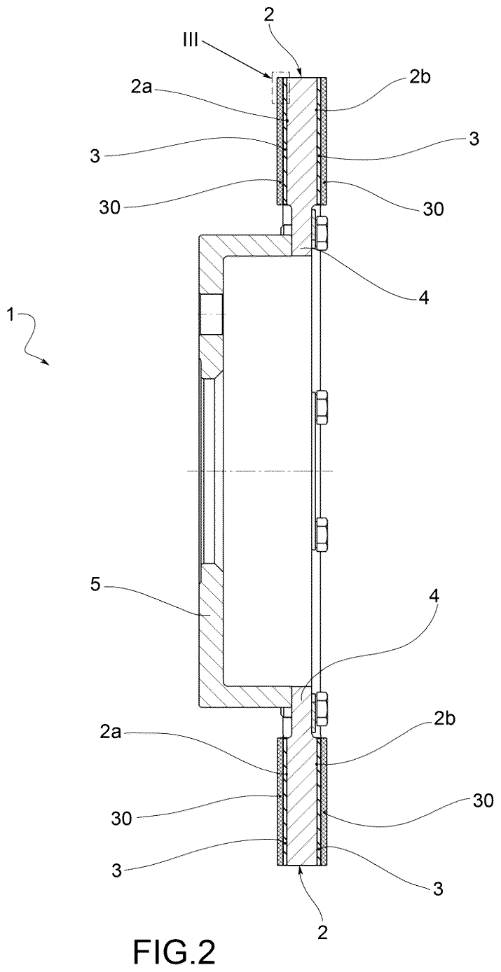

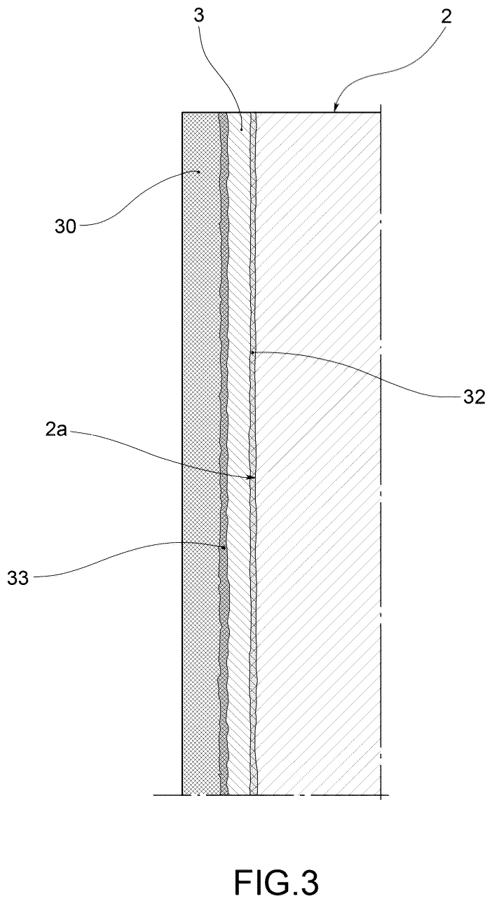

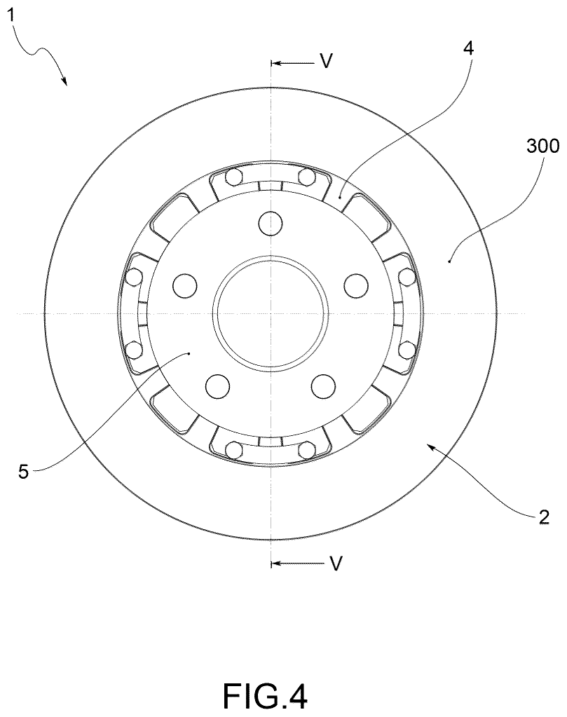

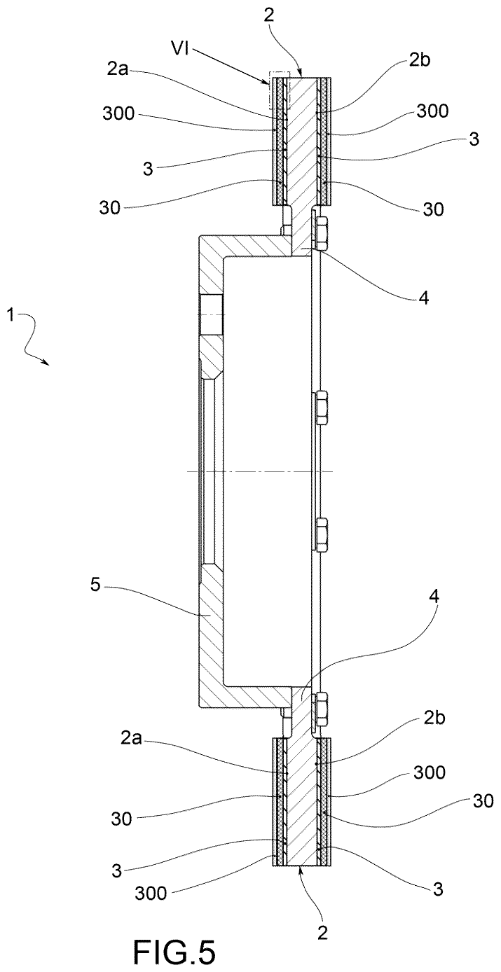

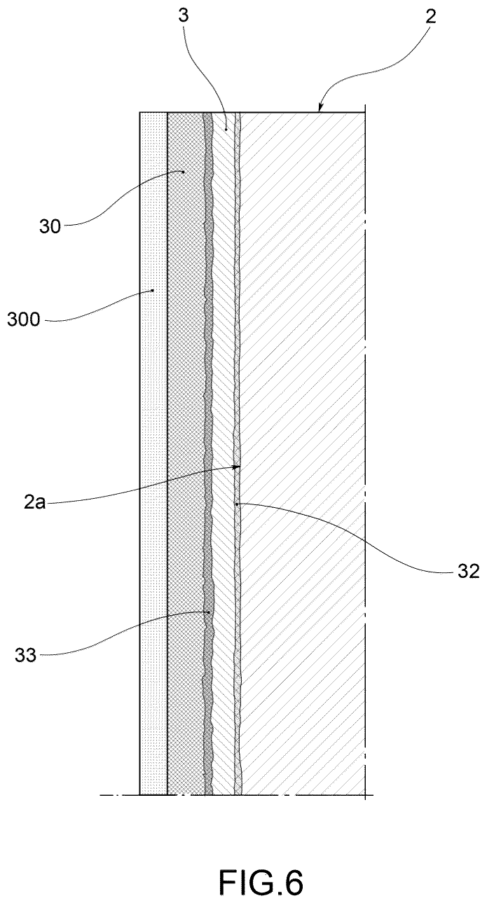

The base layer 30 can:
consist of a titanium or titanium alloy matrix comprising one or more carbides and itself directly define a tribologically active surface of the brake disc 1 (as shown in FIGS. 1, 2 and 3); or
consist of a layer of titanium or a titanium alloy and be in turn covered by a coating layer 300 (as shown in FIGS. 4, 5, and 6).

In turn, in this second case, the coating layer 300 consists of a layer based on one or more carbides and defines a tribologically active surface of the brake disc 1.

The term “tribologically active surface” means a surface of the brake disc on which the braking action of brake pads is directly exerted, with which a braking system of which the brake disc 1 is intended to be part is equipped.

The one or more carbides are selected from the group consisting of titanium carbide (TiC), tungsten carbide (WC), chromium carbide (for example, Cr3C2), niobium carbide (NbC), molybdenum carbide (Mo2C), and silicon carbide (SiC).

The bond layer 3 consists of a layer of titanium, a layer of a titanium alloy, or a layer of steel.

At the interface between the bond layer 3 and the braking band 2 in gray cast iron or steel there is a first intermediate interfusion layer 32 having a mixed composition between the bond layer 3 and the braking band 2.

At the interface between the base layer 30 and the bond layer 3 there is a second intermediate interfusion layer 33 having a mixed composition between the base layer 30 and the bond layer 3.

The base layer 30 and the bond layer 3 both have a crystalline structure with a growth direction that is predominantly orthogonal to the braking surface.

It has surprisingly been found that a base layer 30 and a bond layer 3 thus produced give the brake disc 1 resistance to corrosion and wear, and at the same time are not subject to flaking or delamination (or at least to an extremely small extent compared to coatings in titanium or its known alloys).

The brake disc 1 according to the present invention thus ensures adequate thermal and mechanical performance, demonstrating reliability over time.

Without necessarily wishing to be bound by this theoretical explanation, in relation to the substantial absence of flaking or delamination, it has been hypothesized that:
the two intermediate interfusion layers guarantee in sequence a very stable and resistant connection of the bond layer 3 to the braking band as well as of the base layer 30 to the bond layer 3, since each intermediate interfusion layer is the site of interpenetrations between the two parts; these interpenetrations oppose tensions parallel to the braking surface responsible for delamination and flaking; and
similarly, the crystalline structure with a growth direction predominantly orthogonal to the braking surface interrupts the possible propagation of cracks parallel to the braking surface, which are responsible for delamination and flaking.

The two aspects therefore cooperate synergistically in counteracting delamination and flaking phenomena.

In particular, these two aspects ensure proper adhesion to the braking surface in the presence of thermal loads during braking.

Corrosion resistance derives, instead, from the presence of titanium. In particular, the use of titanium or its alloy guarantees:
corrosion resistance of hundreds of hours in SST,
excellent resistance to hot corrosion, and
good mechanical ductility properties.

The poor wear resistance of titanium is compensated by the presence of carbides, dispersed in the titanium or titanium alloy matrix that forms the base layer 30 or concentrated in the coating layer 300.

The use of a titanium alloy instead of pure titanium improves resistance to thermal shock during braking and at the same time increases hardness with advantages in terms of mileage and reduction of dust emissions.

The presence of the bond layer 3 also brings the following advantages:
it improves the resistance to corrosion towards the braking band, in particular if the latter is made of gray cast iron, and
it prevents cracks on the base layer 30 in the presence of thermal loads from reaching the braking band, in particular if made of gray cast iron; the bond layer 3 protects the braking band as it is sufficiently ductile and resistant to corrosion.

For this purpose, the bond layer 3 is preferably made of pure titanium, precisely because of its ductility and corrosion resistance. Alternatively, with a view to containing costs, the bond layer 3 can be made of steel.

Thanks to the present invention, it is therefore possible to make a brake disc that combines the corrosion resistance of titanium with wear resistance and with a substantial absence of delamination and flaking.

Preferably, the bond layer 3 is the result of the metallurgical bond that is created between at least one of the braking surfaces 2a, 2b and a first particulate composition deposited on the braking surface 2a, 2b with a deposition technique through the use of a laser beam, preferably by the Laser Metal Deposition (LMD) technique. The first particulate composition has a composition equivalent to that of the bond layer 3.

Preferably, the aforementioned base layer 30 is the result of the metallurgical bond that is created between the bond layer 3 and a second particulate composition deposited on the bond layer 3 with a deposition technique through the use of a laser beam, preferably by a Laser Metal Deposition (LMD) technique. The second particulate composition has a composition equivalent to that of the base layer 30.

In particular, the titanium alloy comprises aluminum, preferably with an aluminum content by weight of not less than 2%.

Advantageously, the titanium alloy also comprises vanadium, preferably with a vanadium content of no less than 1% by weight.

Preferably, the titanium alloy is an alloy of titanium, aluminum and vanadium, in which:
aluminum is present with a weight content of between 2% and 8%;
vanadium is present with a weight content of between 1% and 10%; and
the remaining part of the alloy being titanium.

Advantageously, the bond layer 3 has a thickness of between 5 μm and 700 μm, preferably between 50 μm and 400 μm.

Advantageously, the base layer 30 has a thickness of between 5 μm and 700 μm, preferably between 50 μm and 400 μm.

As already pointed out, the base layer 30 may consist of a titanium matrix or a titanium alloy containing one or more carbides, wherein the weight content of carbides is between 2% and 80%. The amplitude of the range is linked to the fact that the density of the usable carbides is highly variable and is reflected in the % by weight. The values closest to 2% of the range are attributable to the lower carbide densities than that of Ti, while the values closest to 80% are attributable to those greater than that of Ti.

Alternatively, the base layer 30 may consist only of titanium or of the titanium alloy.

Advantageously, the coating layer 300 may consist of at least 60% by weight of the one or more of carbides, preferably at least 70% by weight. In this case, the coating layer 300 is constituted by a metal matrix, preferably iron or aluminum based, for the remaining part.

Advantageously, the coating layer 300 can be obtained by:
thermal spray deposition technique, for example by HVOF (High Velocity Oxy-Fuel) technique, or by HVAF (High Velocity Air Fuel) technique or by APS (Atmosphere plasma spray) technique; or
cold spray deposition technique, for example by KM (Kinetic Metallization) technique; or
a deposition technique using a laser beam, for example by the LMD (Laser Metal Deposition) technique, or by the HSLC-high speed laser cladding technique, or by the EHLA—Extreme High Speed Laser Application technique, or by the TSC—Top Speed Cladding technique.

Advantageously, if provided, the coating layer 300 has a thickness of between 10 μm and 150 μm, preferably between 30 μm and 120 μm.

For simplicity of discussion, the brake disc 1 will now be described together with the method according to the present invention. The brake disc 1 is preferably, but not necessarily, made with the method according to the invention that will now be described.

In accordance with a general form of implementation of the method according to the invention, the method comprises the following operating steps:
a) preparing a brake disc, comprising a braking band and equipped with two opposing braking surfaces, each of which at least partially defines one of the two main faces of the brake disc, the braking band being made of gray cast iron or steel;
a1) depositing a first particulate composition comprising titanium, a titanium alloy or steel on at least one of the braking surfaces 2a, 2b by means of a deposition technique using a laser beam, preferably by a Laser Metal Deposition (LMD) technique, forming a bond layer 3 covering at least one of the two braking surfaces 2a, 2b of the braking band 2;
b) depositing a second particulate composition comprising titanium or a titanium alloy on the bond layer 3 by a deposition technique using a laser beam, preferably by a Laser Metal Deposition (LMD) technique, forming a base layer 30 covering the bond layer 3.

Advantageously, the deposition by means of a deposition technique using a laser beam, preferably by a Laser Metal Deposition (LMD) technique, allows:
the formation of a first intermediate interfusion layer having a mixed composition between the bond layer 3 and the braking band 2, at the interface between the bond layer 3 and the braking band 2 in gray cast iron or steel;
the formation of a second intermediate interfusion layer having a mixed composition between the bond layer 3 and the base layer 30, at the interface between the bond layer 3 and the base layer 30; and
the formation of both the base layer 30 and the bond layer 3 having a crystalline structure with a growth direction predominantly orthogonal to the braking surface.

The method according to the invention comprises producing on the at least one braking surface a tribologically active coating layer comprising one or more carbides, according to two alternative methods:
a) including the one or more carbides in the second particulate composition to be deposited in step b), which in this case consists of titanium or a mixture of titanium and one or more titanium alloying metals, and in addition the one or more carbides; in this case, the tribologically active coating layer is constituted directly by the base layer 30; or
b) by depositing on top of the base layer 30 in a step c) subsequent to step b) an additional layer 300 based on the one or more carbides, in which case the second particulate composition to be deposited in step b) consists of titanium or a mixture of titanium and one or more titanium alloying metals; in which case the tribologically active coating layer consists of the additional layer 300.

In both embodiments, the one or more carbides are selected from the group consisting of titanium carbide (TiC), tungsten carbide (WC), chromium carbide (e.g., Cr3C2), niobium carbide (NbC), molybdenum carbide (Mo2C), and silicon carbide (SiC).

In particular, the titanium alloy comprises aluminum, preferably with an aluminum content by weight of not less than 2%.

Advantageously, the titanium alloy also comprises vanadium, preferably with a vanadium content by weight of not less than 1%.

Preferably, the titanium alloy is an alloy of titanium, aluminum, and vanadium, wherein:
aluminum is present with a weight content of between 2% and 8%;
vanadium is present with a weight content of between 1% and 10%; and
the remaining part of the alloy is titanium.

In particular, step a1) can be carried out until a thickness of between 5 μm and 700 μm, preferably between 50 μm and 400 μm, is obtained for the bond layer 3.

In particular, step b) can be carried out until a thickness of between 5 μm and 700 μm, preferably between 50 μm and 400 μm, is obtained for the base layer 30.

Following the aforementioned method a), preferably, in the aforementioned second particulate composition, the weight content of the one or more carbides is between 2% and 80%.

Following the aforementioned method b), preferably in step c), the additional layer 300 is obtained by depositing a third particulate composition in which the weight content of the one or more carbides is at least 60% by weight, preferably at least 70% by weight. The third particulate composition consists of a metal matrix, preferably iron or aluminum based, for the remaining part.

Advantageously, in step c) the third particulate composition can be deposited by:
a thermal spray deposition technique, for example by HVOF (High Velocity Oxy-Fuel) technique, or by HVAF (High Velocity Air Fuel) technique or by APS (Atmosphere plasma spray) technique; or
a cold spray deposition technique, for example by KM (Kinetic Metallization) technique; or
a deposition technique using a laser beam, for example by the LMD (Laser Metal Deposition) technique, or by the HSLC-high speed laser cladding technique, or by the EHLA—Extreme High Speed Laser Application technique, or by the TSC—Top Speed Cladding technique.

In particular, step c) can be carried out until a thickness of between 10 μm and 150 μm, preferably between 30 μm and 120 μm, is obtained for the additional layer 300.

Advantageously, step a1) and step b) can be carried out by using at least one first laser beam having a power between 12 and 22 kW, preferably the laser beam being of the Gaussian or top-hat or top-hat ring type.

In step a1) and in step b), the first and second particulate compositions are deposited with a single nozzle or with two or more nozzles.

Preferably, in step a1) and in step b) the first and second particulate compositions are deposited:
with a total flow rate of between 30 g/min and 300 g/min;
with a tangential speed between 100 m/min and 250 m/min; and
with a deposition rate of between 1 m2/h and 14 m2/h,

Advantageously, during step a1), upstream of the use of the first laser beam, a further laser beam having a power between 1 and 15 kW can be used, preferably the further laser beam being of the Gaussian or top-hat or top-hat ring type. Operationally, the further laser beam carries out a pre-treatment of at least one of the braking surfaces 2a, 2b on which the second particulate composition is intended to be deposited.

Advantageously, if proceeding with mode b), during step b), downstream of the use of the first laser beam, a further laser beam having a power between 1 and 20 kW may be used, preferably the further laser beam being of the Gaussian or top-hat or top-hat ring type. Operationally, the further laser beam performs a post-treatment of at least one of the braking surfaces 2a, 2b on which the second particulate composition was previously deposited to facilitate the adhesion of the additional layer 300.

According to one embodiment, the formation of a metallurgical bond between the substrate and the deposited or welded layers above the substrate occurs by means of one or more laser beams, for example a bifocal laser.

As can be appreciated from what has been described, the brake disc and the method for making the brake disc according to the present invention allow the drawbacks presented in the known technique to be overcome.

It has surprisingly been verified that a brake disc 1 according to the invention combines resistance to corrosion and wear, and at the same time is not subject to flaking or delamination (or at least to an extremely reduced extent compared to coatings in titanium or its known alloys).

The brake disc 1 according to the present invention thus ensures adequate thermal and mechanical performance, showing reliability over time.

Without necessarily wanting to be bound to this theoretical explanation, in relation to the substantial absence of flaking or delamination, it is assumed that:
the two intermediate interfusion layers ensure in sequence a very stable and resistant connection of the bond layer 3 to the braking band as well as the base layer 30 to the bond layer 3, since each intermediate interfusion layer is the site of interpenetrations between the two parts; these interpenetrations oppose tensions parallel to the braking surface responsible for delamination and flaking; and
similarly, the crystalline structure with a growth direction predominantly orthogonal to the braking surface interrupts the possible propagation of cracks parallel to the braking surface, which are responsible for delamination and flaking.

The two aspects therefore cooperate synergistically in counteracting delamination and flaking phenomena.

In particular, these two aspects ensure proper adhesion to the braking surface in the presence of thermal loads during braking.

Corrosion resistance derives, instead, from the presence of titanium. In particular, the use of titanium or its alloy guarantees:
corrosion resistance of hundreds of hours in SST,
excellent resistance to hot corrosion, and
good mechanical ductility properties.

The poor wear resistance of titanium is compensated by the presence of carbides, dispersed in the titanium or titanium alloy matrix that forms the base layer 30 or concentrated in the coating layer 300.

The use of a titanium alloy instead of pure titanium improves resistance to thermal shock during braking and at the same time increases hardness with advantages in terms of mileage and reduction of dust emission.

The presence of the bond layer 3 also brings the following advantages:
it improves the resistance to corrosion towards the braking band, in particular if the latter is made of gray cast iron, and
it prevents cracks on the base layer 30 in the presence of thermal loads from reaching the braking band, in particular if made of gray cast iron; the bond layer 3 protects the braking band as it is sufficiently ductile and resistant to corrosion.

For this purpose, the bond layer 3 is preferably made of pure titanium, precisely because of its ductility and resistance to corrosion. Alternatively, with a view to cost containment, the bond layer 3 can be made of steel.

Thanks to the present invention, it is therefore possible to make a brake disc that combines the corrosion resistance of titanium with wear resistance and with a substantial absence of delamination and flaking.

The brake disc for disc brakes according to the present invention is easy and inexpensive to manufacture.

Finally, the method according to the present invention makes it possible to easily manufacture a brake disc for disc brakes on an industrial scale that is resistant to corrosion and wear, and at the same time is less prone to flaking or delamination.

What is claimed is:

1. A brake disc for disc brakes, comprising a braking band equipped with two opposing braking surfaces, the braking band being made of gray cast iron or steel, the brake disc comprising:
a base layer covering at least one of the two braking surfaces of the braking band, and
a bond layer interposed between the base layer and the least one of the two braking surfaces,
wherein
the base layer consists of a titanium matrix and/or a titanium alloy comprising one or more carbides and defines a tribologically active surface of the brake disc; or
the base layer consists of a layer of titanium and/or a titanium alloy and is in turn covered by a coating layer which consists of a layer based on one or more carbides and defines a tribologically active surface of the brake disc;
wherein the one or more carbides are selected from the group consisting of titanium carbide (TiC), tungsten carbide (WC), chromium carbide, niobium carbide (NbC), molybdenum carbide (Mo2C), and silicon carbide (SiC),
wherein the bond layer consists of a layer of titanium, or of a titanium or steel alloy
and wherein
at an interface between the bond layer and the braking band in gray cast iron or steel there is a first intermediate interfusion layer having a mixed composition between the bond layer and the braking band, and
at an interface between the base layer and the bond layer there is a second intermediate interfusion layer having a mixed composition between the base layer and the bond layer,
the base layer and the bond layer both having a crystalline structure with a growth direction predominantly orthogonal to the least one of the two braking surfaces.

2. The brake disc of claim 1, wherein the bond layer is the result of a metallurgical bond created between the at least one of the two braking surfaces and a first particulate composition deposited on the least one of the two braking surfaces by a deposition technique using a laser beam, optionally the deposition technique using a laser beam being laser metal deposition (LMD), and wherein the first particulate composition has a composition equivalent to that of the bond layer.

3. The brake disc of claim 1, wherein the base layer is the result of a metallurgical bond created between the bond layer and a second particulate composition deposited on the bond layer by a deposition technique using a laser beam, optionally the deposition technique using a laser beam being LMD, and wherein the second particulate composition has a composition equivalent to that of the base layer.

4. The brake disc of claim 1, wherein the titanium alloy comprises aluminum, preferably with an aluminum weight content of not less than 2%.

5. The brake disc of claim 4, wherein the titanium alloy further comprises vanadium, preferably with a vanadium content by weight of not less than 1%.

6. The brake disc of claim 1, wherein the titanium alloy is an alloy of titanium, aluminum and vanadium, and wherein aluminum is present with a weight content of between 2% and 8% and vanadium is present with a weight content of between 1% and 10%, a remaining part of the alloy being titanium.

7. The brake disc of claim 1, wherein the bond layer has a thickness of between 5 μm and 700 μm, preferably between 50 μm and 400 μm.

8. The brake disc of claim 1, wherein the base layer has a thickness between 5 μm and 700 μm, preferably between 50 μm and 400 μm.

9. The brake disc of claim 1, wherein he base layer consists of titanium or of the titanium alloy.

10. The brake disc of claim 1, wherein the base layer consists of the titanium matrix or the titanium alloy comprising one or more carbides, and wherein a weight content of the one or more carbides is between 2% and 80%.

11. The brake disc of claim 1, wherein the coating layer consists of at least 60% by weight of the one or more carbides, preferably at least 70% by weight.

12. The brake disc of claim 11, wherein the coating layer consists of a metal matrix for a remaining part.

13. The brake disc of claim 1, wherein the coating layer is obtained by a thermal spray deposition technique, optionally the thermal spray deposition technique being high velocity oxy-fuel (HVOF), or high velocity air fuel (HVAF), or atmosphere plasma spray (APS).

14. The brake disc of claim 1, wherein the coating layer is obtained by a cold spray deposition technique, optionally the cold spray deposition technique being kinetic metallization (KM).

15. The brake disc of claim 1, wherein the coating layer is obtained by a deposition technique using a laser beam, optionally the deposition technique using a laser beam being LMD, or speed laser cladding (HSLC), or extreme high speed laser application (EHLA), or top speed cladding (TSC).

16. The brake disc of claim 1, wherein the coating layer has a thickness of between 10 μm and 150 μm, preferably between 30 μm and 120 μm, more preferably between 50 μm and 90 μm.

17. A method for making a brake disc, the method comprising the following operating steps:
a) preparing a brake disc comprising a braking band equipped with two opposing braking surfaces, the braking band being made of gray cast iron or steel;
a1) depositing a first particulate composition comprising titanium, a titanium alloy, or steel on at least one of the two braking surfaces by a deposition technique using a laser beam, optionally the deposition technique using a laser beam being laser metal deposition (LMD), forming a bond layer covering at least one of the two braking surfaces of the braking band;
b) depositing a second particulate composition comprising titanium or a titanium alloy on the bond layer by a deposition technique using a laser beam, optionally the deposition technique using a laser beam being LMD, forming a base layer covering the bond layer;
wherein the method comprises forming on the at least one of the two braking surfaces a tribologically active coating layer comprising one or more carbides:
including the one or more carbides in the second particulate composition to be deposited in step b), which in this case comprises titanium or a mixture of titanium and one or more titanium alloying metals, and in addition the one or more carbides, in this case the tribologically active coating layer being constituted directly by the base layer; or
depositing on the base layer in a step c) subsequent to step b) an additional layer based on the one or more carbides, in which case the second particulate composition to be deposited in step b) consists of titanium or a mixture of titanium and one or more titanium alloying metals, in which case the tribologically active coating layer is constituted by the additional layer, and
wherein the one or more carbides are selected from the group consisting of titanium carbide (TiC), tungsten carbide (WC), chromium carbide, niobium carbide (NbC), molybdenum carbide (Mo2C), and silicon carbide (SiC).

18. The method of claim 17, wherein the titanium alloy comprises aluminum, preferably with an aluminum content by weight of not less than 2%.

19. The method of claim 18, wherein the titanium alloy further comprises vanadium, preferably with a vanadium content by weight of not less than 1%.

20. The method of claim 17, wherein the titanium alloy is an alloy of titanium, aluminum and vanadium, and wherein aluminum is present with a weight content of between 2% and 8% and vanadium is present with a weight content of between 1% and 10%, a remaining part of the alloy being titanium.

21. The method of claim 17, wherein step b) is carried out until a thickness of between 5 μm and 700 μm, preferably between 50 μm and 400 μm, is obtained for the bond layer.

22. The method of claim 17, wherein step b) is conducted until a thickness of between 5 μm and 700 μm, preferably between 50 μm and 400 μm, is obtained for the base layer.

23. The method of claim 17, wherein in the second particulate composition a weight content of the one or more carbides is between 2% and 80%.

24. The method of claim 17, wherein in step c) the additional layer is obtained by depositing a third particulate composition in which a content by weight of the one or more carbides is at least 60% by weight, preferably at least 70% by weight.

25. The method of claim 24, wherein the particulate composition consists of a metal matrix for a remaining part.

26. The method of claim 24, wherein in step c) the third particulate composition is deposited by:
a thermal spray deposition technique, optionally the thermal spray deposition technique being high velocity oxy-fuel (HVOF), or high velocity air fuel (FHVAF), or atmosphere plasma spray (APS); or
a cold spray deposition technique, optionally the cold spray deposition technique being kinetic metallization (KM); or
a deposition technique using a laser beam, optionally the deposition technique using a laser beam being LMD, or high speed laser cladding (HSCL), or extreme high speed laser application (EHLA), or top speed cladding (TSC).

27. The method of claim 24, wherein step c) is conducted until a thickness of between 10 μm and 150 μm, preferably between 30 μm and 120 μm, is obtained for the additional layer.

28. The method of claim 17, wherein step a1) and step b) are conducted by using at least one first laser beam having a power between 12 and 22 kW, preferably the laser beam being of one of a Gaussian, a or top-hat, or a top-hat ring type.

29. The method of claim 17, wherein in step a1) and step b) the first and second particulate compositions are deposited with a single nozzle or with two or more nozzles:
with a total flow rate of between 30 g/min and 300 g/min;
with a tangential speed between 100 m/min and 250 m/min; and
with a deposition rate between 1 m2/h and 14 m2/h.

30. The method of claim 28, wherein during step a1), upstream of the use of the at least one first laser beam, a further laser beam having a power between 1 and 15 kW is used, preferably the further laser beam being of one of a Gaussian, a top-hat, or a top-hat ring type, the further laser beam performing a pre-treatment of the at least one of the two braking surfaces on which the first particulate composition is intended to be deposited.

31. The method of claim 28, wherein during step b), downstream of the use of the at least one first laser beam, a further laser beam having a power between 1 and 20 kW is used, preferably the further laser beam being of one of a the Gaussian, or a top-hat, or a top-hat ring type, the further laser beam performing a post-treatment of the at least one of the two braking surfaces on which the second particulate composition has been previously deposited.
